(19) United States
(12) Patent Application Publication
(10) Pub. No.: US 2011/0261244 A1
(43) Pub. Date: Oct. 27, 2011

(54) IMAGE PROCESSING APPARATUS, IMAGE REPRODUCING APPARATUS, IMAGING APPARATUS AND PROGRAM RECORDING MEDIUM

(75) Inventors: Tomoyuki Ogawa, Kawasaki-shi (JP); Morihiro Takagi, Yokohama-shi (JP); Junko Hasegawa, Atsugi-shi (JP)

(73) Assignee: NIKON CORPORATION, Tokyo (JP)

(21) Appl. No.: 13/177,230

(22) Filed: Jul. 6, 2011

Related U.S. Application Data
(63) Continuation of application No. 12/219,914, filed on Jul. 30, 2008, now abandoned.

(30) Foreign Application Priority Data
Feb. 6, 2007 (JP) JP2007-026575
Aug. 2, 2007 (JP) JP2007-201925

(51) Int. Cl. H04N 5/225

(52) U.S. Cl. 348/333.01; 348/E05.024

(57) ABSTRACT

An image processing apparatus has a data reading section, a controlling section, and a display section. The data reading section reads a reproduced file selected from a first file and a second file. Here, the first file includes data of a first image together with metadata indicating a location of a second image related to the first image. The second file includes the data of the first image but do not include the metadata. The controlling section detects the metadata from the reproduced file. The display section performs display of indicating existence of the second image on a first screen reproducing the first image of the reproduced file when the controlling section detects the metadata.

### CROSS-REFERENCE TO RELATED APPLICATION

This application is a continuation application of U.S. patent application Ser. No. 12/219,914 filed Jul. 30, 2008, which is a continuation-in part application of U.S. patent application Ser. No. 12/010,499, filed Jan. 25, 2008, and claims the benefit of priority from Japanese Patent Application No. 2007-026575, filed on Feb. 6, 2007 and No. 2007-201925, filed on Aug. 2, 2007, the entire contents of which are incorporated herein by reference.

### BACKGROUND

1. Field

The present invention relates to an image processing apparatus, an image reproducing apparatus and an imaging apparatus which have a function to reproduce and display a captured image, and a program thereof.

2. Description of the Related Art

In a typical electronic camera, conventionally there is provided a function to reproduce and display a captured image on a monitor. Further, regarding reproduction of an image in an electronic camera, there is also proposed a structure in which a table of link information indicating relation among images is recorded separately from data of the images, and thereby related images are displayed sequentially based on this link information. For example, Japanese Unexamined Patent Application Publication No. 2000-4420 discloses an example of the above-described electronic camera.

However, in the conventional electronic camera, the table of link information is prepared separately from image files so as to manage relation among the image files. Accordingly, there is room for improvement in that the number of recorded image files may be limited by the capacity of the table of link information that is recorded in a recording medium.

In addition, conventionally, there are known electronic cameras having a function to reproduce and display a captured image on a monitor as described in Japanese Unexamined Patent Application Publication No. 2003-158646. Further, in part of models of electronic cameras, there are known ones having a function to perform image compilation on a captured image and record the image after compilation separately from the image as a compilation source.

Incidentally, in conventional electronic cameras, the image as a compilation source and the image after the compilation are not always recorded with consecutive numbers. Therefore, when confirming the effect of image compilation via reproduction and display, there arises a need for searching the image as a compilation source and the image after compilation by forwarding frames, which obliges the user to perform complicated operation. Thus, there has been room for improvement in this aspect.

### SUMMARY

The present invention is made to solve at least one of the above-described technical problems. One of objects of the present invention is to provide a measure by which reproduction of related images and the like can be performed more easily.

Further, another one of objects of the present invention is to provide a measure by which the user can easily compare images before and after compilation from image compilation.

An image processing apparatus according to a first invention has a data reading section, a controlling section, and a display section. The data reading section reads a reproduced file selected from a first file and a second file. Here, the first file includes data of a first image together with metadata indicating a location of a second image related to the first image. The second file includes the data of the first image but do not include the metadata. The controlling section detects the metadata from the reproduced file. The display section performs display of indicating existence of the second image on a first screen reproducing the first image of the reproduced file when the controlling section detects the metadata.

In a second invention according to the first invention, the second image is either of an original image which is a compilation source for the first image when the first image is generated by image processing and a compilation image generated by image processing the first image.

In a third invention according to the second invention, the metadata include path information indicating a location of the original image.

In a fourth invention according to the second invention, the metadata include path information indicating a location of the compilation image.

In a fifth invention according to the first to the fourth invention, the image processing apparatus further includes an operation section which accepts an input from a user. Further, the controlling section changes to a related image displaying mode based on an input by the operation section when the metadata are detected, reads the reproduced file corresponding to the second image based on the metadata, and switches a display screen on the display section from the first screen to a second screen which reproduces and displays the second image.

In a sixth invention according to the fifth invention, the display section displays on the second screen an indication of being in the related image displaying mode. Further, the controlling section causes the display screen of the display section to return to the first screen based on an input by the operation section during the related image displaying mode.

In a seventh invention according to the fifth invention, the display section displays on the second screen an indication of being in the related image displaying mode. Further, the controlling section releases the related image displaying mode based on an input by the operation section and changes to a state that another image can be reproduced and displayed by the display section, during the related image displaying mode.

An eighth invention is an image reproducing apparatus capable of reproducing a first image and a second image generated by performing image compilation on the first image. This image reproducing apparatus includes a data reading section which reads a first image file including data of the first image and a second image file including data of the second image, a display section which performs reproduction and display of an image, an operation section which accepts an input from a user, and a controlling section which controls the reproduction and display according to an input with the operation section. Then, one of when first identification data indicating the second image generated from the first image is included in the first image file and when second identification data indicating the first image as a compilation source of the second image is included in the second image file, the controlling section displays on the display section a comparison screen which displays the first image and the second image before and after image compilation simultaneously based on at least one of the first identification data and the second identification data.

In a ninth invention according to the eighth invention, the controlling section changes a display state of the display section to a screen enlarging and displaying the specified image when there is an input to specify the first image or the second image while the comparison screen is displayed.

In a tenth invention according to the eighth invention, the controlling section displays based on the third identification data a mark indicating the existence of the original image on the comparison screen when the first image is an image generated by performing image compilation on an original image and the first image file further includes third identification data indicating the original image. Further, the controlling section changes the comparison screen to a state displaying the original image and the first image simultaneously according to an input with the operation section.

In an eleventh invention according to the eighth invention, the controlling section displays based on the fourth identification data a mark indicating the existence of the third image on the comparison screen when a third image generated by performing image compilation on the second image exists and the second image file further includes fourth identification data indicating the third image. Further, the controlling section changes the comparison screen to a state displaying the second image and the third image simultaneously according to an input with the operation section.

In a twelfth invention according to the eighth invention, the controlling section displays a mark indicating that a plurality of the second images exist for the first image on the comparison screen when the first image file includes a plurality of the first identification data. Further, the controlling section changes the second image on the comparison screen according to an input with the operation section.

In a thirteenth invention according to the eighth invention, the controlling section displays a mark indicating that a plurality of the first images exist for the second image on the comparison screen when the second image file includes a plurality of the second identification data. Further, the controlling section changes the first image on the comparison screen according to an input with the operation section.

In a fourteenth invention according to the eighth invention, the second image file further includes data indicating contents of image compilation related to the second image. Then the controlling section displays the contents of the image compilation on the comparison screen.

In a fifteenth invention according to any one of the eighth to fourteenth inventions, the image reproducing apparatus further includes an image processing section which generates data of the second image by performing image compilation on data of the first image. Then, the controlling section records the first identification data in the first image file and records the second identification data in the second image file, during the image compilation.

Here, an imaging section which images a subject and generates data of an image may be added to the structure of the above-described image processing apparatus or image reproducing apparatus to thereby form an imaging apparatus. Further, one in which the contents of the above-described inventions are represented by converting them into an image processing method, an image reproducing method, a program which causes a computer to function as an image processing apparatus or an image reproducing apparatus, a recording medium recording the above program, or the like is also effective as a specific mode of the present invention.

### BRIEF DESCRIPTION OF THE DRAWINGS

FIG. 1 is a block diagram showing a structure of an electronic camera of one embodiment.

FIG. 2 is a view showing a structure of a rear part of the electronic camera of the one embodiment.

FIG. 3 is a view schematically showing a data structure of an image file in the one embodiment.

FIG. 4 is a flowchart showing an operation when viewing plural images in a reproduction mode of the one embodiment.

FIG. 5 is a flowchart continued from FIG. 4.

FIG. 6 is a diagram schematically showing relation of images in the one embodiment.

FIG. 7 is a view showing an example of a display screen of a monitor in S106.

FIG. 8 is a view showing an example of a display screen of the monitor in S109.

FIG. 9 is a view showing an example of a display screen of the monitor in S115.

FIG. 10 is a block diagram showing a structure of an electronic camera of another embodiment.

FIG. 11 is a schematic view showing data structure of an image file in the another embodiment.

FIG. 12 is a view showing an example of a menu screen of an image compilation mode of the another embodiment.

FIG. 13 is a flowchart explaining an operation example of an electronic camera in image comparison before and after compilation in the another embodiment.

FIG. 14 is a view showing an example of a comparison screen in S208.

FIG. 15 is a view showing a new comparison screen changed from the comparison screen in FIG. 14.

FIG. 16 is a view showing a new comparison screen changed from the comparison screen in FIG. 14.

FIG. 17 is a view showing a new comparison screen changed from the comparison screen in FIG. 14.

### DETAILED DESCRIPTION OF THE EMBODIMENTS

### Explanation of One Embodiment

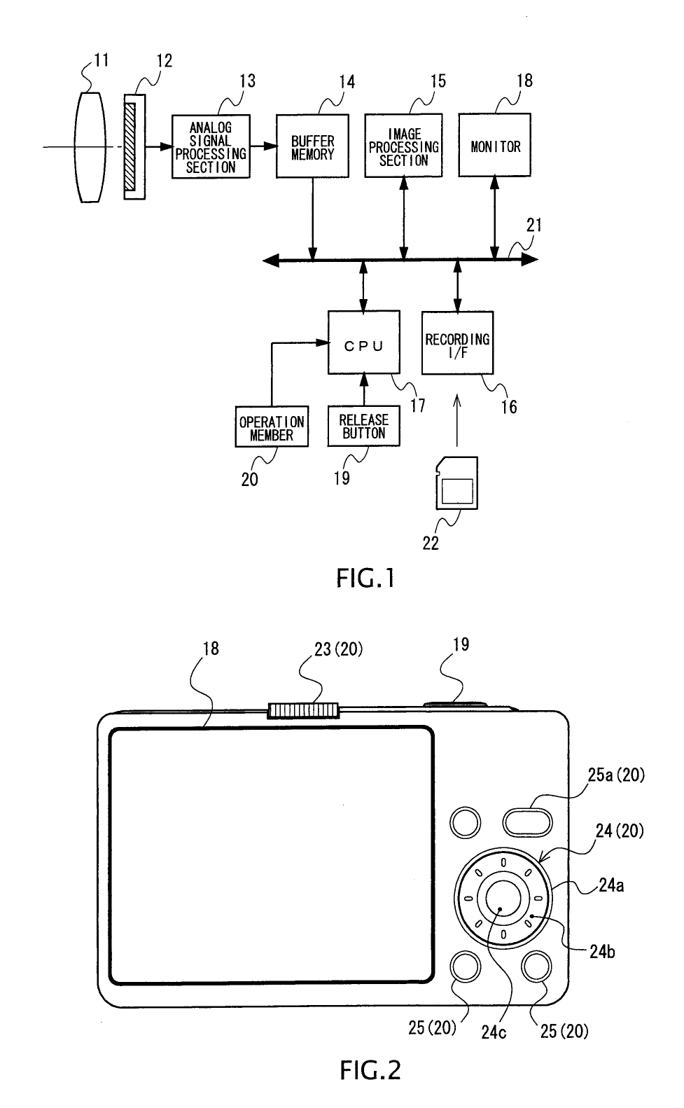

FIG. 1 is a block diagram showing a structure of an electronic camera of one embodiment. Further, FIG. 2 is a view showing a structure of a rear part of the electronic camera of the one embodiment.

The electronic camera has an imaging optical system 11, an imaging element 12, an analog signal processing section 13, a buffer memory 14, an image processing section 15, a recording I/F 16, a CPU 17, a monitor 18, a release button 19 and an operation member 20, and a bus 21. Here, the buffer memory 14, the image processing section 15, the recording I/F 16, the CPU 17 and the monitor 18 are connected with each other via the bus 21. Further, the release button 19 and the operation member 20 are each connected to the CPU 17.

The imaging element 12 is arranged on the image space side of the imaging optical system 11. The imaging element 12 generates an analog image signal by photoelectrically converting a subject image generated by optical flux passing through the imaging optical system 11. An output of this imaging element 12 is connected to the analog signal processing section 13.

The analog signal processing section 13 is an analog front-end circuit which performs analog signal processing on an output of the imaging element 12. This analog signal processing section 13 performs correlated double sampling, adjustment of the gain of an image signal, A/D conversion of an image signal, and the like. In addition, an output of the analog signal processing section 13 is connected to the buffer memory 14. The buffer memory 14 temporarily stores data of photographed image or the like before and after image processing by the image processing section 15.

The image processing section 15 is an ASIC which performs various types of image processing (white balance correction, color interpolation processing, color correction, color conversion processing, gradation conversion, edge enhancement processing, color space conversion, and the like) on a digital image signal.

Further, the image processing section 15 executes compilation processing of data of a main image in a reproduction mode, which will be described later. In the aforementioned compilation processing, the image processing section 15 performs image processing on data of a main image as a compilation source so as to generate data of a new compilation image (an image generated by performing image processing on the image as a compilation source) separately from the main image as a compilation source.

In addition, the types of image processing executed by the image processing section 15 in the compilation processing include, for example, edge enhancement processing, contrast correction processing, red-eye correction processing, chroma adjustment processing, noise reduction processing, optical amount correction processing involving image analysis (processing of specifying a dark section or a highlight section of an image based on results of the image analysis and adjusting gradation of the specified section mainly), image combining processing of combining one image from plural images, and the like.

In the recording I/F 16, a connector for connecting a recording medium 22 is formed. Then the recording I/F 16 executes writing/reading of data to/from the recording medium 22 connected to the connector. The aforementioned recording medium 22 is formed by a hard disk, a memory card including a semiconductor memory, or the like. Incidentally, FIG. 1 shows the memory card as an example of the recording medium 22.

The CPU 17 is a processor performing overall control of the electronic camera. The CPU 17 controls the operation of each part of the electronic camera according to a sequence program corresponding to an operation mode (imaging mode, reproduction mode, or the like as an example). For example, the CPU 17 in the imaging mode executes imaging processing of the main image, various calculations (AF calculation, AE calculation, auto white balance calculation, and the like) which are needed before imaging. Note that explanation for the aforementioned reproduction mode will be given later.

Further, the CPU 17 generates an image file in compliance with the Exif (Exchangeable image file format for digital still cameras) standard. In addition, the image files generated by the CPU 17 are recorded in the aforementioned recording medium 22.

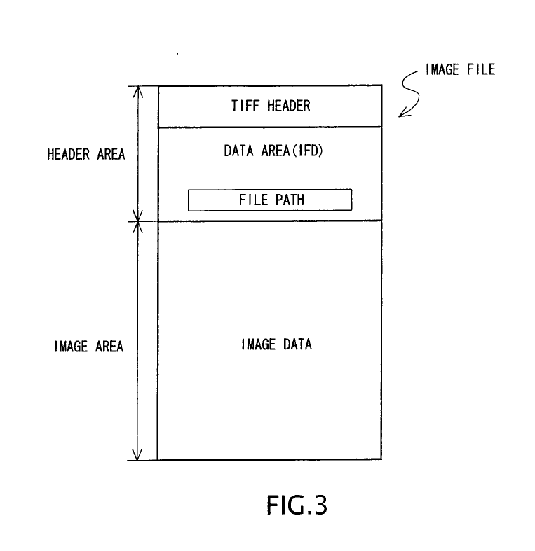

Here, FIG. 3 schematically shows a data structure of an image file. The image file has a header area in which metadata commencing with imaging conditions (exposure time, aperture value, imaging sensitivity, and the like) are recorded and an image area in which data of an image are recorded. Further, the header area of the image file is formed by a TIFF header and a data area (IFD).

In addition, among data included in the image file, data to which the Exif standard does not correspond are recorded in the header area of the image file using the MakerNote tag of the Exif standard.

The monitor 18 displays various images according to instruction by the CPU 17. As shown in FIG. 2, the monitor 18 of the one embodiment is formed by a liquid crystal display provided on the rear face of the camera case. Incidentally, the structure of the monitor 18 may be an electronic finder having an eyepiece part, or the like. Here, on the monitor 18 in the reproduction mode, a screen reproducing the image of an image file is displayed.

The release button 19 accepts an instruction input of AF by a half-pressing operation and an instruction input of release timing by a full-pressing operation (start of exposure of the main image) from the user.

The operation member 20 has, as shown in FIG. 2, a mode dial 23, a multi-selector 24, and plural input buttons 25. The mode dial 23 accepts a switching operation of the operation mode of the electronic camera from the user.

Further, the multi-selector 24 has a main part 24a, an enter button 24b, and a dial part 24c. The overall shape of the main part 24a of the multi-selector 24 is formed in a circular shape, and is formed to be capable of inclining in four directions, upward, downward, leftward, and rightward. This main part 24a accepts from the user, for example, a switching operation of a reproduced image to be displayed on the monitor 18 in the reproduction mode. The enter button 24b of the multi-selector 24 is arranged in a center part of the multi-selector 24. The dial part 24c of the multi-selector 24 has an overall shape formed in a ring shape, and is formed to be capable of pivoting on the outer periphery of the enter button 24b. These dial part 24c and enter button 24b accept from the user, for example in the reproduction mode, an operation of an icon (selection of an item and decision of an item) displayed on the monitor 18 in a GUI (Graphical User Interface) format.

Further, the respective input buttons 25 accept input operations set for the respective operation modes from the user. In addition, the input buttons 25 include a reproduction button 25a which starts the reproduction mode.

Hereinafter, an operation example in the reproduction mode of the electronic camera of the one embodiment will be explained.

First, a case that the user performs compilation processing of an image in the reproduction mode will be explained.

When the user performs an operation to start the reproduction mode (for example, operating the mode dial 23, pressing the reproduction button 25a), the CPU 17 reproduces and displays an image recorded in an image file on the screen of the monitor 18. While displaying this reproduction screen, when the user specifies an item of compilation processing with the operation member 20, the CPU 17 generates an image file of a compilation image in the following manner.

Firstly, the image processing section 15 performs the image processing specified by the user on data of an image as a compilation source (an image being displayed on the reproduction screen). Then, the image processing section 15 generates data of a new compilation image separately from the image as a compilation source.

Secondly, the CPU 17 generates respective data of the header area of the compilation image in compliance with the Exif standard. In addition, for the metadata of imaging conditions for the compilation image, data of the image file of the compilation source are duplicated and recorded.

Thirdly, in the header area of the image file of the compilation image, the CPU 17 records data indicating the type of the image processing in the compilation processing and a file path indicating the location of the image file of the compilation source. Incidentally, in the case of image combining processing, plural file paths of image files as compilation sources are recorded in the header area.

Further, the CPU 17 records in the header area of the image file of the compilation source a file path indicating the location of the image file of the compilation image. Accordingly, when a file path is detected from the header area of an image file, the CPU 17 can comprehend the location of another image file related to this image file.

Here, the aforementioned file paths are formed by, as an example, character string data or the like describing a route to the recording position of a target image file from the root directory or the drive name as a start point. Of course, the file path may be a relative path. In addition, data of the aforementioned file paths are all recorded in the respective header areas using the MakerNote tag.

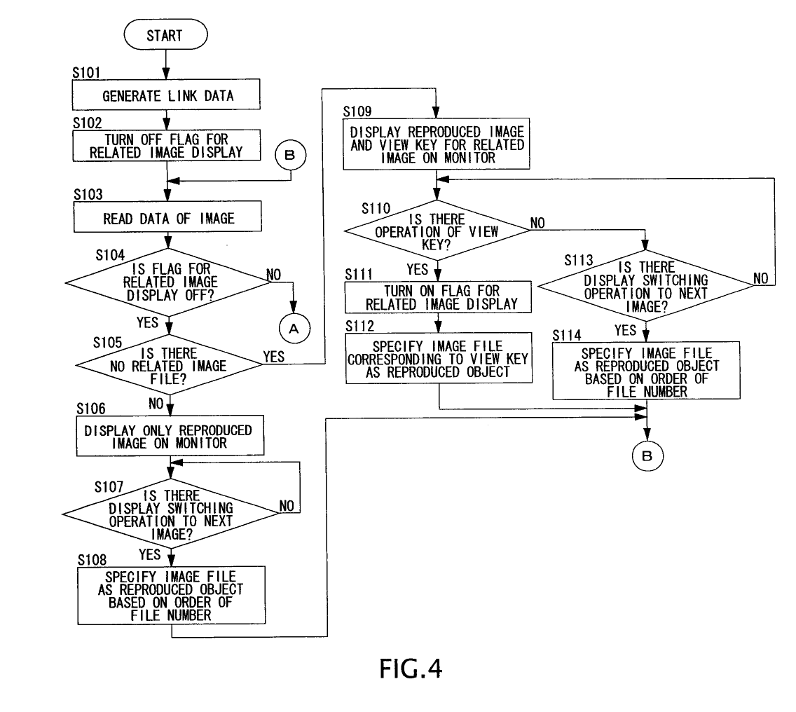

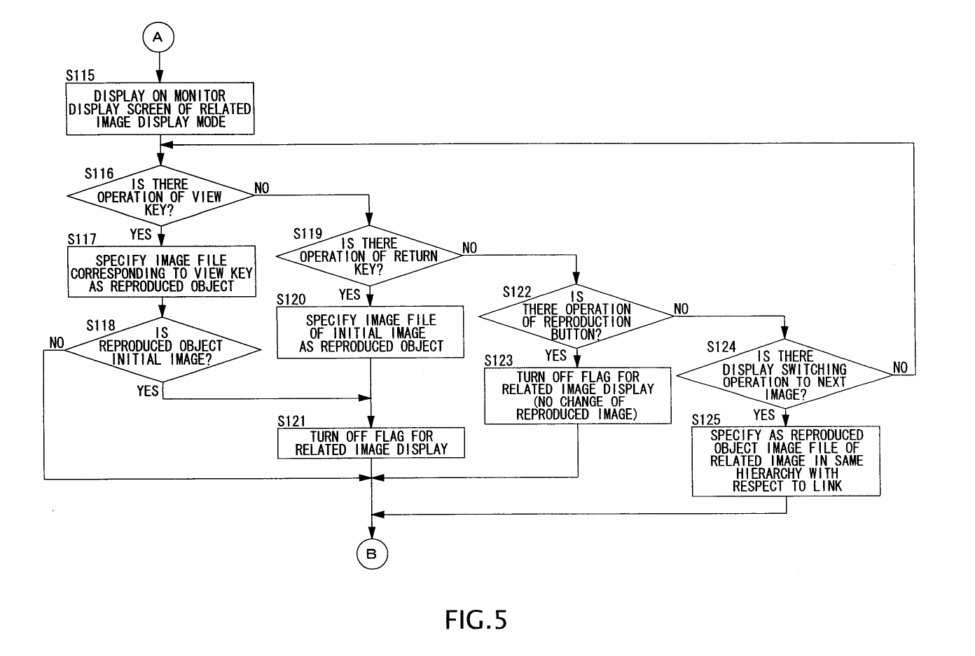

Next, an operation when the user switches the displayed image on the monitor 18 so as to view plural images in the reproduction mode will be explained with reference to the flowcharts of FIG. 4 and FIG. 5.

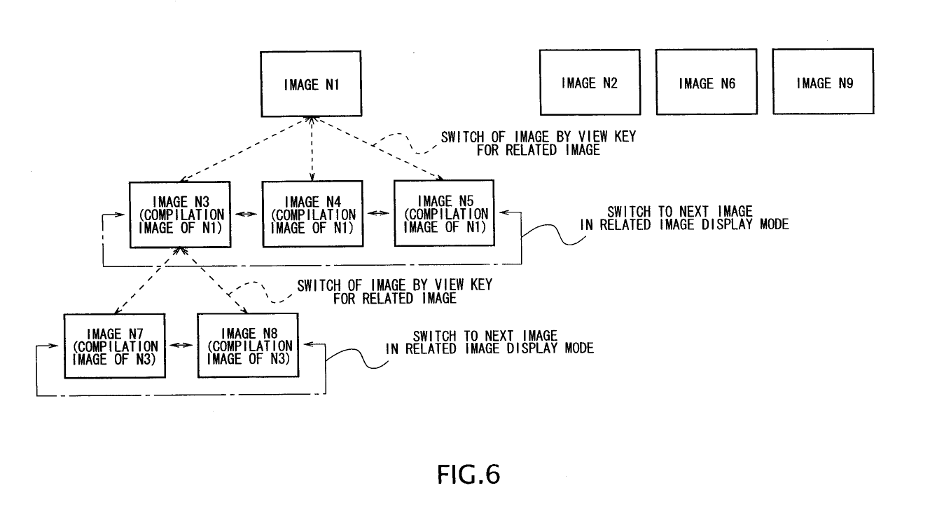

Here, in examples of FIG. 4 and FIG. 5, for convenience of explanation, it is assumed that image files of nine frames from image N1 to image N9 recorded in the recording medium 22 are reproduced. The numbers of the aforementioned images (N1 to N9) indicate that the order of the file numbers of the respective images. Further, the images up to N3, N4, N5 are compilation images with the image N1 being the original image. Furthermore, the images N7, N8 are compilation images with the image N3 being the original image. Incidentally, relation of the aforementioned respective images is shown schematically in FIG. 6.

Step 101: the CPU 17 scans the header areas of all the image files recorded in the recording medium 22. Then the CPU 17 generates link data indicating relation between an original image and a compilation image among the image files based on file paths detected from the header areas of the image files. By generating the link data, the CPU 17 can comprehend relation of the image files with each other hierarchically. Therefore, the CPU 17 becomes capable of extracting plural compilation images (the images N3, N4, N5 with respect to the image N1, the images N7, N8 with respect to the image N3, as an example) having direct relation to the same original image in a related manner by the link data.

Step 102: the CPU 17 turns a flag for related image display to off-state for initialization.

Step 103: the CPU 17 reads data of an image from an image file as a reproduced object. In addition, when an image as a reproduced object is read for the first time in the reproduction mode, the CPU 17 reads an image from the image file with the first (N1) or the last (N9) file number.

Step 104: the CPU 17 determines whether the flag for related image display is in off-state or not. When the flag is in off-state (YES side), the CPU 17 proceeds to S105. Otherwise, when the flag is in on-state (NO side), the CPU 17 proceeds to S115. Note that in this case (NO side in S104), the CPU 17 operates in a related image displaying mode, which will be described later.

Step 105: the CPU 17 determines whether there is no image file related to the image file as the reproduced object (S103). Specifically, the CPU 17 refers to the link data (S102) to determine whether there is no original image or compilation image for the image as the reproduced object. When there is no related image file (NO side), the CPU 17 proceeds to S106. Otherwise, when there is a related image file (YES side), the CPU 17 proceeds to S109.

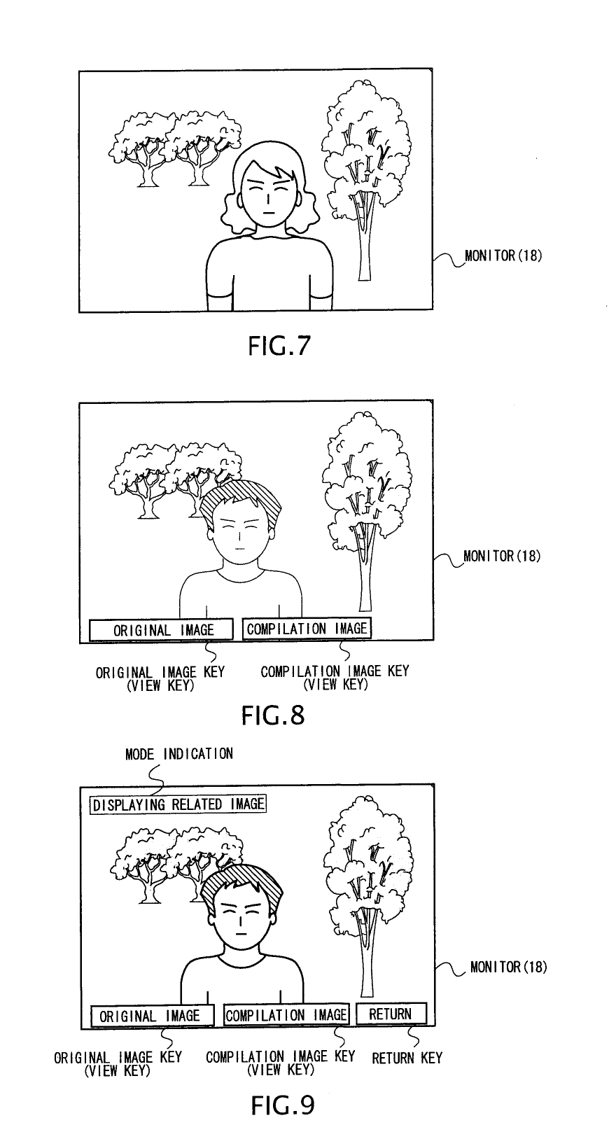

Step 106: in this case, the CPU 17 displays only the reproduced image read from the image file as the reproduced object on the monitor 18. Incidentally, an example of the display screen of the monitor 18 in S106 is shown in FIG. 7.

Step 107: the CPU 17 determines whether a display switching operation to the next image (for example, an operation by the main part 24a of the multi-selector 24) is accepted from the user or not. When this condition is met (YES side), the CPU 17 proceeds to S108. Otherwise, when this condition is not met (NO side), the CPU 17 waits for an input from the user.

Step 108: the CPU 17 specifies as the reproduced object an image file which is located just after (or just before) the image file as the reproduced object in the order of the file numbers. Thereafter, the CPU 17 returns to S103 to repeat the above operation.

As an example, it is assumed that the user performs the display switching operation to the next image when the image N2 is displayed in S106. In this case, according to the order of the file numbers, the image N3 (or image N1) is displayed on the monitor 18 after the switching.

Step 109: in this case, the CPU 17 displays the reproduced image read from the image file as the reproduced object and view keys for related images on the monitor 18. FIG. 8 shows an example of a display screen of the monitor 18 in S109. On the display screen in FIG. 8, the view keys for related images are displayed in a GUI format on a lower side of the reproduced image.

Here, there are two types of the aforementioned view keys: an original image key for viewing the original image for the reproduced image and a compilation image key for viewing a compilation image of the reproduced image. The original image key is displayed on the monitor 18 only when the CPU 17 determines that the original image for the reproduced image exists based on the link data. Similarly, the compilation image key is displayed on the monitor 18 only when the CPU 17 determines that a compilation image generated from the reproduced image exists based on the link data. Incidentally, FIG. 8 shows a state that both the original image key and the compilation image key are displayed on the monitor 18.

Then, when the user performs input on a view key by manipulating the cursor or the like on the monitor 18 with the operation member 20, the CPU 17 displays the related image (original image or compilation image) corresponding to the view key on the monitor 18. Here, when there are plural compilation images generated from the reproduced image being displayed, the CPU 17 displays, upon input on the view key for a compilation image, the compilation image with the oldest file number among the aforementioned compilation images. In addition, the CPU 17 may be configured to display an arbitrary compilation image specified by the user on the monitor 18 when there are plural compilation images generated from the reproduced image being displayed.

Step 110: the CPU 17 determines whether an input operation of a view key for a related image is accepted or not. When this condition is met (YES side), the CPU 17 proceeds to S111. Otherwise, when this condition is not met (NO side), the CPU 17 proceeds to S113.

Step 111: the CPU 17 turns on the flag for related image display. Further, the CPU 17 records the file path of the image file (image file of an initial image) that is the current reproduced object.

Step 112: the CPU 17 specifies as the reproduced object the image file (original image or compilation image) corresponding to the view key. Thereafter, the CPU 17 returns to S103 to repeat the above operation. Note that in this case, since the flag for related image display is in on-state, the CPU 17 changes in the above-described S104 to a related image displaying mode (S115), which will be described later.

As an example, it is assumed that the user performs input on the view key (compilation image key) when the image N1 is displayed in S109. In this case, the CPU 17 proceeds to the related image displaying mode, and the image N3 is displayed on the monitor 18 after the switching. Note that explanation for the display screen in the related image displaying mode will be given later in S115.

Step 113: the CPU 17 determines whether a display switching operation to the next image (for example, an operation by the main part 24a of the multi-selector 24) is accepted from the user or not. When this condition is met (YES side), the CPU 17 proceeds to S114. Otherwise, when this condition is not met (NO side), the CPU 17 returns to S110 and repeats the above operation.

Step 114: the CPU 17 specifies as the reproduced object an image file which is located just after (or just before) the image file as the reproduced object in the order of the file numbers. Thereafter, the CPU 17 returns to S103 to repeat the above operation.

As an example, it is assumed that the user performs the display switching operation to the next image when the image N1 is displayed in S109. In this case, according to the order of the file numbers, the image N2 (or image N9) is displayed on the monitor 18 after the switching.

Step 115: the CPU 17 in the related image displaying mode displays an original image or a compilation image of the immediately preceding displayed image on the monitor 18. FIG. 9 shows an example of a display screen of the monitor 18 in S115. On the display screen in FIG. 9, a mode indication indicating that it is in the related image displaying mode is displayed together with the related image. Further, on a lower side of the related image, the view keys for related images (the original image key and the compilation image key) and a return key are displayed in the GUI format.

Here, when the user performs input on the return key by manipulating the cursor or the like displayed on the monitor 18 by the operation member 20, the CPU 17 displays again on the monitor 18 the initial image which was displayed before entering the related image displaying mode. Further, when the user presses the reproduction button 25a in the display state of the display screen in S115, the CPU 17 releases the related image displaying mode and changes to the normal display state. Note that explanation for the view keys for related images is in common with S109, and hence the duplicating explanation is omitted.

Step 116: the CPU 17 determines whether an input operation of a view key for a related image is accepted or not. When this condition is met (YES side), the CPU 17 proceeds to S117. Otherwise, when this condition is not met (NO side), the CPU 17 proceeds to S120.

Step 117: the CPU 17 specifies as the reproduced object the image file (original image or compilation image) corresponding to the view key.

Step 118: the CPU 17 determines whether the image file specified as the reproduced object in S117 is an initial image or not. Specifically, the CPU 17 determines whether or not the file path of the image file specified as the reproduced object in S117 matches with the file path recorded in S111. When this condition is met (YES side), the CPU 17 proceeds to S121. Otherwise, when this condition is not met (NO side), the CPU 17 returns to S103 while remaining in the related image displaying mode and repeats the above operation.

In addition, the NO side in S118 corresponds to a situation such that, for example, the display is switched from the image N1 to the image N3 by operating the view key, and is further switched from the image N3 to the image N7 by operating the view key.

Step 119: the CPU 17 determines whether an input operation of the return key is accepted or not. When this condition is met (YES side), the CPU 17 proceeds to S120. Otherwise, when this condition is not met (NO side), the CPU 17 proceeds to S122.

Step 120: the CPU 17 specifies as the reproduced object the image file of the initial image based on the file path recorded in S111.

Step 121: this step corresponds to a situation such that the display is switched to the initial image before entering the related image displaying mode. Accordingly, the CPU 17 turns the flag for related image display to an off-state, so as to release the related image displaying mode. Thereafter, the CPU 17 returns to S103 and repeats the above operation.

Incidentally, situations corresponding to the case of S121 include, for example: (1) when the user switches the display from the image N1 to the image N3 by operating the view key, and thereafter returns the display from the image N3 to the image N1 by operating the view key (YES side in S118), (2) when the user switches the display in the order of the images N1, N3, N7 by operating the view key, and thereafter returns the display to the image N1 by the return key (YES side in S119), and the like.

Step 122: the CPU 17 determines whether an input operation of the reproduction button 25a is accepted or not. When this condition is met (YES side), the CPU 17 proceeds to S123. Otherwise, when this condition is not met (NO side), the CPU 17 proceeds to S124.

Step 123: the CPU 17 turns the flag for related image display to an off-state, so as to release the related image displaying mode. Thereafter, the CPU 17 returns to S103 and repeats the above operation without changing the image file as the reproduced object. In this case, the image being the current reproduced object is displayed on the monitor 18 in the state of S109 (in other words, a state that the mode indication and the return key are not displayed).

Step 124: the CPU 17 determines whether a display switching operation to the next image (for example, an operation by the main part 24a of the multi-selector 24) is accepted from the user or not. When this condition is met (YES side), the CPU 17 proceeds to S125. Otherwise, when this condition is not met (NO side), the CPU 17 returns to S116 and repeats the above operation.

Step 125: based on the link data, the CPU 17 extract other related images belonging to the same hierarchy as the display image in S115 on the basis of the image as the link source. Then, in the group of the aforementioned related images, the CPU 17 specifies as the reproduced object an image file which is located just after (or just before) the image file as the reproduced object in the order of the file numbers. Thereafter, the CPU 17 returns to S103 and repeats the above operation.

As an example, it is assumed that the user performs the display switching operation to the next image after the user switches the display from the image N1 to the image N3 and then changes to the related image displaying mode by operating the view key. In this case, the CPU 17 extracts the images N4, N5 in the same hierarchy as the display image (N3) with respect to the image (N1) as the link source. Then, every time the switching operation to the next image is performed while remaining in the related image displaying mode, the images are displayed on the monitor 18 in the order of N4, N5, N3, N4, . . . , repeatedly. Besides, when no other related images exist in S125, the CPU 17 considers the switching operation to the next image as invalid and proceeds to S116. Thus, the explanation of FIG. 4 and FIG. 5 is completed.

Hereinafter, the operation and effect of the one embodiment will be explained. In the electronic camera of the one embodiment, the CPU 17 manages relation of image files based on the file path recorded in the header area of an image file. Then, when there is a compilation image or the like for the image being reproduced, the CPU 17 notifies this to the user by displaying the view key on the monitor 18. Further, the CPU 17 proceeds to the related image displaying mode in response to an operation of the view key by the user so as to facilitate viewing of the group of images related to the image as the link source. In addition, on the monitor 18 in the related image displaying mode, the mode indication to indicate the related image displaying mode is performed, and hence the user does not get confused.

For example, considering a case that an original image and a compilation image are not recorded with sequential numbers, in the normal reproduction mode the user is required to perform operations to skip non-related images sequentially so as to compare the two images. However, in the above-described embodiment, since the user can switch displaying of an original image and a compilation image easily by operating the view keys, the user can easily recognize the effect of image compilation by comparing the original image and the compilation image. Further, the user can easily perform switching of display to the initial image which is shown before entering the related image displaying mode as well as releasing of the related image displaying mode, and hence the convenience in the reproduction mode of the electronic camera improves further.

Further, in the one embodiment, the CPU 17 generates the link data as necessary based on the file paths recorded in the header areas of image files. Thus, management of relation among images during reproduction can be performed efficiently with fewer amounts of data.

### Explanation of Another Embodiment

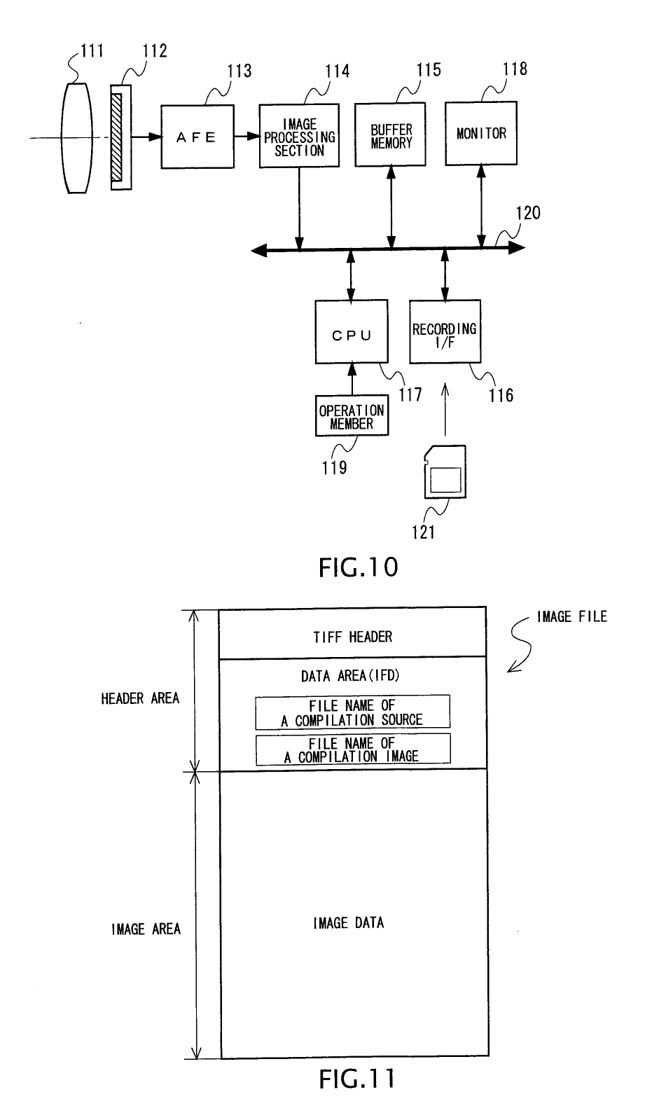

FIG. 10 is a block diagram showing the structure of an electronic camera of another embodiment. The electronic camera has an imaging optical system 111, an imaging element 112, an AFE 113, an image processing section 114, a buffer memory 115, a recording I/F 116, a CPU 117, a monitor 118, an operation member 119, and a bus 120. Here, the image processing section 114, the buffer memory 115, the recording I/F 116, the CPU 117 and the monitor 118 are connected with each other via the bus 120. Further, the operation member 119 is connected to the CPU 117.

The imaging optical system 111 has a plurality of lens groups including a zoom lens, a focusing lens, and/or the like. In FIG. 10, for simplicity, the imaging optical system 111 is shown as one lens. Note that for an electronic camera of single reflex type, the lens unit including the imaging optical system 111 is structured to be replaceable with respect to the electronic camera.

The imaging element 112 generates an analog image signal by photoelectrically converting a subject image generated by optical flux passing through the imaging optical system 111. An output of this imaging element 112 is connected to the AFE 113. Note that in a photographing mode which is one of operation modes of the electronic camera, the imaging element 112 images a recording image (main image) in response to a full-pressing operation of a release button, which will be described later.

The AFE 113 is an analog front-end circuit which performs analog signal processing on an output of the imaging element 112. This AFE 113 performs correlated double sampling, adjustment of the gain of an image signal, A/D conversion of an image signal, and the like. In addition, an output of the AFE 113 is connected to the image processing section 114.

The image processing section 114 is an ASIC which performs various types of image processing (white balance correction, color interpolation processing, color correction, color conversion processing, gradation conversion, edge enhancement processing, color space conversion, and the like) on a digital image signal. Further, the image processing section 114 also performs resolution conversion processing of an image, or the like.

Furthermore, the image processing section 114 executes image compilation processing of data of a main image in an image compilation mode, which will be described later. In the aforementioned image compilation processing, the image processing section 114 performs image processing on data of an image as a compilation source so as to generate data of a new compilation image (an image generated by performing image processing on the image as a compilation source) separately from the image as a compilation source.

The buffer memory 115 temporarily stores data of an image or the like before and after image processing by the image processing section 114.

In the recording I/F 116, a connector for connecting a recording medium 121 is formed. Then the recording I/F 116 executes writing/reading of data to/from the recording medium 121 connected to the connector. The aforementioned recording medium 121 is formed by a hard disk, a memory card including a semiconductor memory, or the like. Incidentally, FIG. 10 shows the memory card as an example of the recording medium 121.

The CPU 117 is a processor performing overall control of the electronic camera. The CPU 117 controls the operation of each part of the electronic camera according to a sequence program corresponding to an operation mode (photographing mode, reproduction mode, image compilation mode, or the like as an example). For example, the CPU 117 in the photographing mode executes imaging processing of the main image, various calculations (AF calculation, AE calculation, auto white balance calculation, and the like) which are needed before imaging.

Further, the CPU 117 generates an image file in compliance with the Exif standard. The image file generated by the CPU 117 is recorded in the aforementioned recording medium 121.

Here, FIG. 11 schematically shows a data structure of an image file. The image file has a header area in which metadata including imaging conditions (exposure time, aperture value, imaging sensitivity, and the like) are recorded and an image area in which data of an image are recorded. Further, the header area of the image file is formed by a TIFF header and a data area (IFD). In addition, among data included in the image file, data that is not specified by the Exif standard is recorded in the header area of the image file using the MakerNote tag of the Exif standard. Further, when generating an image file related to a compilation image, the CPU 117 generates metadata using the imaging condition of an image file as a compilation source.

Incidentally, the CPU 117 in the reproduction mode reads data of an image file from the recording medium 121 and displays a reproduced image on the monitor 118. The monitor 118 displays various images according to instruction by the CPU 117.

The monitor 118 of the another embodiment is formed by a liquid crystal display provided on the rear face of the camera case. Incidentally, the structure of the monitor 118 may be an electronic finder having an eyepiece part, or the like. In addition, the CPU 117 can also display on the monitor 118 a menu screen on which various setting items can be input.

The operation member 119 accepts various input operations from the user. The operation member 119 in the another embodiment includes a release button, a cross cursor key, and a decision button. The release button of the operation member 119 accepts in the photographing mode an instruction input of AF by a half-pressing operation and an instruction input to start imaging of a main image by a full-pressing operation from the user. Further, the cursor key and the decision button of the operation member 119 accept various operations according to respective operation modes from the user. For example, the CPU 117 in the image compilation mode accepts an operation of an icon (selection of an item and decision of an item) displayed on the monitor 18 in a GUI format from the user via the cursor key and the decision button of the operation member 119.

Hereinafter, an operation example in the image compilation mode of the electronic camera of the another embodiment will be explained. For example, in a state that an image is reproduced on the monitor 118 in the reproduction mode, the CPU 117 displays, upon detection of an operation of starting the image compilation mode, a menu screen of the image compilation mode on the monitor 118.

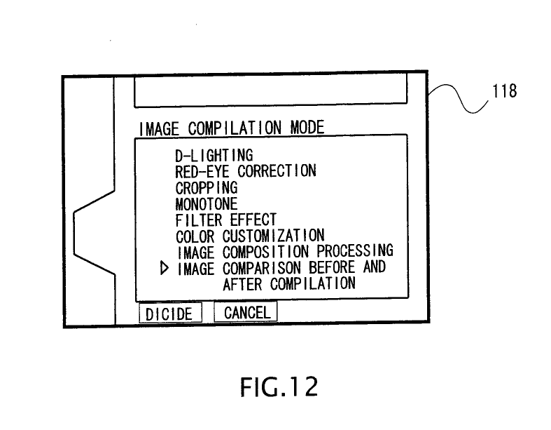

FIG. 12 is a view showing an example of the menu screen of the image compilation mode. In this menu screen, processing items which can be selected in the image compilation mode are displayed in a list. Specifically, in the menu screen of FIG. 12, there are displayed items “D-lighting”, “red-eye correction processing”, “cropping”, “monotone”, “filter effect”, “color customization”, “image composition processing”, and “image comparison before and after compilation”. Note that display processing and the like in the above-described menu screen are all controlled by the CPU 117.

In the above items, the “D-lighting”, the “red-eye correction processing”, the “cropping”, the “monotone”, the “filter effect”, the “color customization”, and the “image composition processing” are items all related to the contents of image compilation processing. In addition, the item “image comparison before and after compilation” turns to an unselectable state when the reproduced image displayed during the reproduction mode is irrelevant to the image compilation (when having no identification data in the image file, which will be described later).

Here, the contents of the image compilation processing in the above menu screen will be explained. In the “D-lighting”, the image processing section 114 specifies a dark portion or a highlight portion in the image as a compilation source by image analysis, and adjusts gradation of the image around the dark portion or the highlight portion, and thereby generates a compilation image. In the “red-eye correction processing”, the image processing section 114 reduces red-eyes of a person included in the image as a compilation source by image processing, and thereby generates a compilation image. For example, the image processing section 114 detects a red-eye region from a face region in an image by a publicly known face detection processing, and perform correction to lower the brightness or the chroma of the detected red-eye region. In the “cropping”, the image processing section 114 partially cuts out an image as the processing target and thereby generates a compilation image. In the “monotone”, the image processing section 114 generates a compilation image expressing the image as a compilation source by gradation or brightness/darkness of single color. In the “filter effect”, the image processing section 114 performs image processing on the image as a compilation source and thereby generates a compilation image similar to one while filter is coupled. For example, the image processing section 114 performs image processing to suppress blue in the image as a compilation source (skylight), image processing to make the image as a compilation source have a warm color (warm tone), or the like as the “filter effect”. In the “color customization”, the image processing section 114 adjusts the color tone of the image as a compilation source, and thereby generates a compilation image. Further, in the “image composition processing”, the image processing section 114 combines two images as sources of compilation to generate one compilation image.

Further, when generating an image file of a compilation image, the CPU 117 records identification data indicating the image as a compilation source in the header area. Specifically, the CPU 117 records the image file name of a compilation source in the header area of an image file of a compilation image. Particularly, in the “image composition processing”, the CPU 117 records image file names of two compilation sources in the header area. Further, the CPU 117 records contents (cropping or the like) of image compilation processing in the header area of an image file of a compilation image. In addition, the image file of a compilation image generated in the image compilation mode is eventually recorded in the recording medium 121 under control by the CPU 117.

On the other hand, the CPU 117 records identification data (image file name of a compilation image) indicating a compilation image generated from an original image also in the header area of the image file of a compilation source. Note that when the image file of a compilation source is in a state that writing of data is disabled for preventing tampering of the image, the CPU 117 omits recording of the identification data to the image file of the compilation source.

Here, when a plurality of different image compilation processings are performed on one image, a plurality of image file names of compilation images are recorded in one image file. In addition, when image compilation processing is further performed on the above compilation image, the image file name as the compilation source for the image and the image file name of a compilation image derived further from the image are recorded in one image file (refer to FIG. 11).

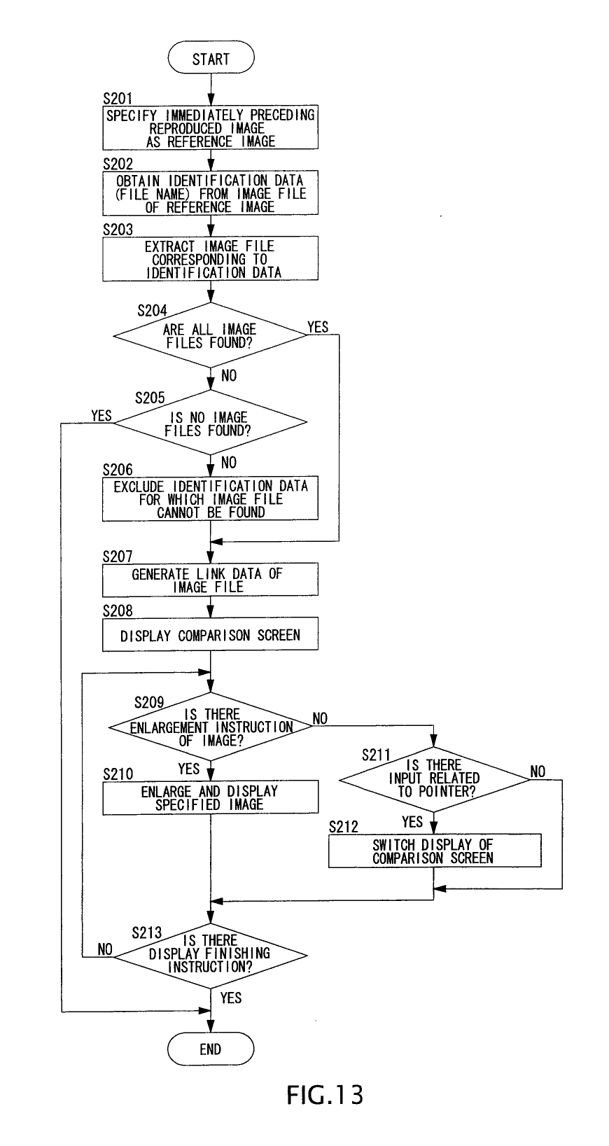

Next, with reference to a flowchart of FIG. 13, an operation example of the electronic camera when the item “image comparison before and after compilation” is selected will be explained in detail. In this “image comparison before and after compilation”, a comparison screen displaying two images before and after image compilation processing simultaneously are displayed on the monitor 118 under control by the CPU 117.

Step S201: the CPU 117 specifies a reproduction image displayed on the monitor 118 before starting the image compilation mode as a reference image.

Step S202: CPU 117 refers to the header area of the image file of the reference image (S201) and obtains identification data (the image file name of a compilation source or the image file name of a compilation image) included in this image file. Thus, the CPU 117 becomes able to search for the image as a compilation source and a compilation image related to the reference image in the recording medium 121.

Step S203: the CPU 117 extracts an image file matching with the file name of the identification data (S202) among image files recorded in the recording medium 121.

Here, the CPU 117 confirms the header area in the image file after extracting the above image file, and excludes any image that is irrelevant to the reference image. As an example, the CPU 117 focuses attention on the “total number of releases” in the header area included in an image file of the Exif standard. Then, when the “total number of releases” of the extracted image file is different from the value of the image file of the reference image, the CPU 117 excludes this image file. This is because, after an original image or the like is deleted from the recording medium 121, it is possible that another image is recorded with the same file name as the original image. Incidentally, when there is identification data indicating the image file of the reference image, the CPU 117 may determine it as an image file relevant to the reference image.

Step S204: the CPU 117 determines whether all the image files corresponding to the identification data (S202) are found or not. When this condition is met (YES side), the CPU 117 proceeds to S207. Otherwise, when this condition is not met (NO side), the CPU 117 proceeds to S205.

Step S205: the CPU 117 determines whether no image file corresponding to the identification data (S202) is found. When this condition is met (YES side), the CPU 117 displays a message about that no other image relevant to the reference image exists on the monitor 118, and finishes the processing of FIG. 13 without displaying the above-described comparison screen. Otherwise, when this condition is not met (NO side), the CPU 117 proceeds to S206.

Step S206: the CPU 117 exclude, from the processing target, identification data for which an image file cannot be found among the identification data included in the image file of the reference image. Here, the identification data excluded from the processing target in S206 are not used for generating link data, which will be explained later.

Step S207: according to the processing result in S203, the CPU 117 generates link data indicating correspondence before and after compilation between image files. This link data is used by the CPU 117 when switching the image compared on the comparison screen.

Specifically, the CPU 117 generates the link data targeted at the image file of the reference image and the image file extracted in S203 (an image file of a compilation source of the reference image or an image file of a compilation image of the reference image) among image files recorded in the recording medium 121.

Further, the CPU 117 read identification data also from the image file extracted in S203 and records in the link data about how many images as a compilation source and/or how many compilation images exist for these image files.

Step S208: the CPU 117 displays the comparison screen for the image comparison before and after compilation on the monitor 118. In the aforementioned comparison screen, under control by the CPU 117, two images (an image as a compilation source and a compilation image) before and after image compilation processing are simultaneously displayed side by side horizontally in a scaled-down state. Note that in the comparison screen of the another embodiment, the image as a compilation source is displayed on a left side, and the compilation image is displayed on a right side.

Further, on the comparison screen, image file names of the respective displayed images and contents of image compilation recorded in the image file of the compilation image are displayed under control by the CPU 117. Note that the CPU 117 displays on the comparison screen pointers for switching images to be compared based on the aforementioned link data (S207).

FIG. 14 shows an example of the comparison screen in S208. Here, in the following example, a reference image N1 is a compilation image generated by performing image compilation processing on an image N2. Further, it is assumed that for the image N2, there exists a compilation image N3 different from the reference image N1. Further, images N4, N5 are compilation images generated by performing image compilation processing on the reference image N1 respectively. It is assumed that the image N5 is a compilation image (combined image) generated by combining the reference image N1 and the image N6. Furthermore it is assumed that the image N7 is a compilation image generated by performing image compilation processing on the image N4.

In an initial state (FIG. 14) of the comparison screen in S208, the CPU 117 displays, side by side on the monitor 118, the reference image N1 (left side in FIG. 14) and the compilation image N4 for the image N1 (right side in FIG. 14). Further, on the reference image N1 of the comparison screen, a cursor for selection is displayed overlapping under control by the CPU 117.

Further, based on the link data (S207), the CPU 117 displays on the comparison screen pointers indicating other images related to the reference image N1 and pointers indicating other images related to the compilation image N4 being displayed. In FIG. 14, on the left side of the reference image N1, a pointer indicating the image N2 as the compilation source of the reference image N1 is displayed. Further, on a lower side of the compilation image N4 in FIG. 14, a pointer indicating the compilation image N5 for the reference image N1 is displayed. Moreover, on the right side of the compilation image N4 in FIG. 14, a pointer indicating the compilation image N7 is displayed.

In addition, as an example, when an image file of the compilation image N5 does not exist in the recording medium 121, the CPU 117 does not generate link data for the image N5 (S206), and thus the pointer indicating the compilation image N5 is no longer displayed on the comparison screen in FIG. 14.

Then, the user can perform selecting a displayed image on the comparison screen or specifying one of the pointers with respect to the CPU 117 by operating the cursor on the screen with the operation member 119. When an input of enlargement instruction is accepted in a state that the cursor is positioned on a displayed image on the comparison screen, the CPU 117 enlarges and displays the image specified by the cursor. Further, when an input to specify the direction of a pointer is further accepted in a state that the cursor is positioned on the displayed image on the comparison screen, the CPU 117 performs switching of display on the comparison screen.

Step S209: the CPU 117 determines whether an input of enlargement instruction of one image on the comparison screen is accepted or not. When the input exists (YES side), the CPU 117 proceeds to S210. Otherwise, when the input does not exist (NO side), the CPU 117 proceeds to S211.

Step S210: the CPU 117 enlarges and displays the image specified by the cursor on the comparison screen. For example, the CPU 117 displays in full screen the one image on the comparison screen on the monitor 118 in the same format as reproduction in the normal reproduction mode. Note that after release of the enlargement display in S210, the CPU 117 advances the process to S213.

Step S211: the CPU 117 determines whether an input related to a pointer on the comparison screen is accepted or not. When this input exists (YES side), the CPU proceeds to S212. Otherwise, when this input does not exist (NO side), the CPU 117 proceeds to S213.

Step S212: the CPU 117 performs switching of display of the comparison screen (S208). Specifically, the CPU 117 leaves one image included in the original comparison screen, and replaces the other image with the image corresponding to the pointer specified. Then, the CPU 117 displays the two images after replacement side by side on the comparison screen. Further, the CPU 117 generates new link data in the same manner as in the processing from above-described S202 to S208, and displays pointer also on the new comparison screen in S212 based on the link data.

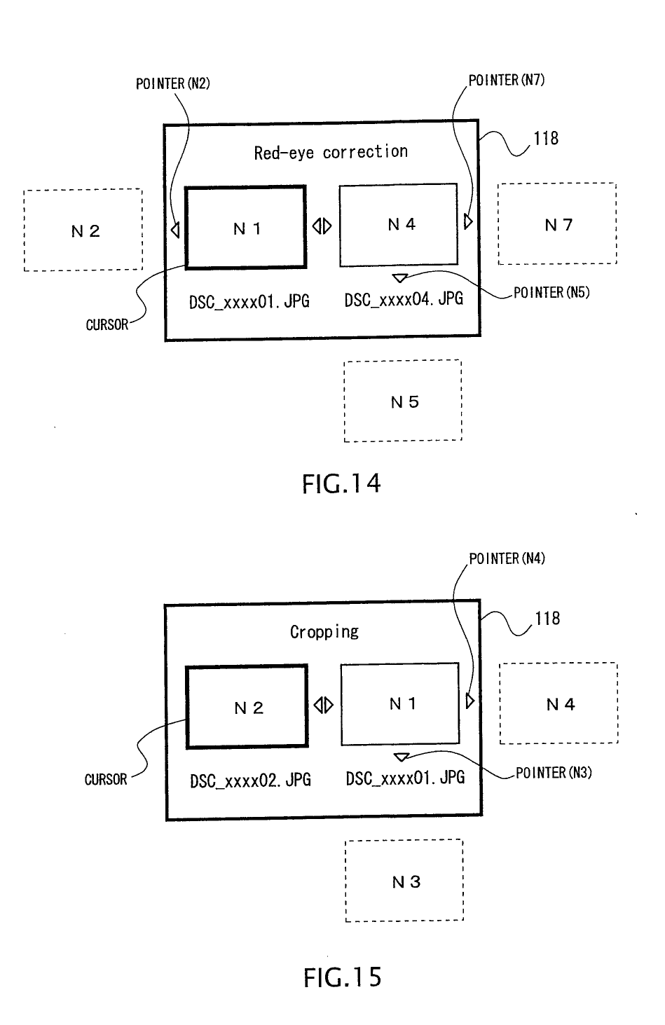

FIG. 15 to FIG. 17 are views showing respectively new comparison screens changed according to input on a pointer from the comparison screen in FIG. 14. FIG. 15 shows a new comparison screen changed by the pointer indicating the image N2. On the comparison screen in FIG. 15, the image N2 (left side in FIG. 15) as a compilation source and the image N1 (right side in FIG. 15) as a compilation image of the image N2 are displayed side by side horizontally. Then on a lower side of the image N1 in FIG. 15, a pointer indicating the image N3 that is a compilation image of the image N2 is displayed. Further, on the right side of the image N1 in FIG. 15, a pointer indicating the image N4 as a compilation image of the image N1 is displayed.

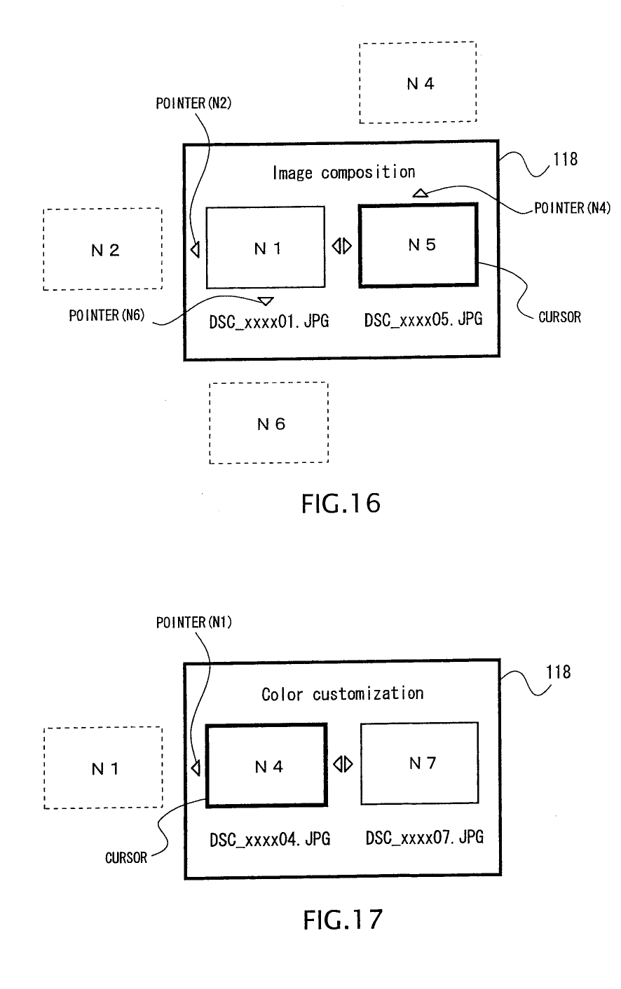

FIG. 16 shows a new comparison screen changed by the pointer indicating the image N5. On the comparison screen in FIG. 16, the image N1 (left side in FIG. 16) as one compilation source, and the image N5 (right side in FIG. 16) that is a combined image using the image N1 are displayed side by side horizontally. Then, on the left side of the image N1 in FIG. 16, a pointer indicating the image N2 that is the compilation source of the image N1 is displayed. Further, on a lower side of the image N1 in FIG. 16, a pointer indicating the image N6 that is an image as the other compilation source for the image N5 is displayed. Furthermore, on an upper side of the image N5 in FIG. 16, a pointer indicating the image N4 as a compilation image of the image N1 is displayed.

FIG. 17 illustrates a new comparison screen changed by the pointer indicating the image N7. In the comparison screen of FIG. 17, the image N4 (left side in FIG. 17) as a compilation source and the image N7 (right side in FIG. 17) as a compilation image of the image N4 are arranged side by side horizontally. Then, on the left side of the image N4 in FIG. 17, a pointer indicating the image N1 that is an image as the compilation source for the image N4 is displayed.

Step S213: the CPU 117 determines whether a display finishing instruction for the comparison screen is accepted or not. When the display finishing instruction exists (YES side), the CPU 117 finishes the processing in FIG. 13. Otherwise, when the display finishing instruction does not exist (NO side), the CPU 117 returns to S209 to repeat the above operation. Thus, the explanation of FIG. 13 is finished.

Hereinafter, the operation and effect of the electronic camera of the another embodiment will be explained. In the electronic camera of the another embodiment, the CPU 117 displays images before and after image compilation side by side on the monitor 118 based on identification data recorded in an image file. Then in response to operation by the user, the CPU 117 enlarges and displays one image displayed on the comparison screen. Accordingly, in the structure of the another embodiment, the user can confirm the effect of image compilation easily and quickly by comparing and observing the image as a compilation source and a compilation image.

Furthermore, considering the case where an original image and a compilation image are not recorded with consecutive numbers, in the normal reproduction mode the user needs to perform operation of sequentially forwarding irrelevant images so as to compare the two images. However, in the above-described embodiment, since image groups having relevance due to image compilation can be switched and displayed easily on the comparison screen, the usefulness of the electronic camera improves further.

### Supplementary Items to the Embodiment

(1) In the above-described embodiments, an example in which an image is reproduced in the digital camera is explained. However, in the present invention, an image processing apparatus and an image reproducing apparatus similar to the electronic camera of the above-described embodiments may be formed by a viewer (photo storage or PDA for example) or a mobile phone having a function to reproduce an image file or by a general-purpose computer which executes an image reproduction program. Incidentally, in the above-described one embodiment, the program of the image processing apparatus is executed by the CPU 17.

(2) In the above-described one embodiment, there is explained an example in which a file path is recorded in each of the image file of an original image and the image file of a compilation image with respect to each other. Further, in the above-described another embodiment, there is explained an example in which file names are recorded mutually in the image file of an original image and the image file of a compilation image. However, the present invention is not limited to the above-described embodiment, and the file path (or the file name) of an opponent image may be recorded in only one of the image file of a compilation image and the image file of an original image. In this case, it is preferable that the file path (or the file name) of the original image is recorded in the image file of a compilation image in particular.

(3) In the above-described one embodiment, when a folder or the like for recording image files is predetermined, the CPU 17 may manage relation of the image files by recording, instead of the file path, information (file name for example) by which an opponent image file can be identified. Similarly, in the above-described another embodiment, there is explained an example in which correlation of image files before and after compilation is managed by file names, but the CPU 117 may be configured to record, in the header area of one image file, character string information (path) indicating the location of the other image file.

(4) In the above-described embodiments, when deleting an image file in which a file path (or file name) is recorded in the header area, the CPU may update or delete the file path (or file name) of the image file of a compilation image or an original image which is relevant to the object of deletion. For example, when deleting the original image, the CPU may relate the image file of the remaining compilation image again to an original image that is higher in order than the deleted image.

(5) In the above-described one embodiment, there is shown an example in which the image file of a compilation image is generated during image processing in the reproduction mode, but the embodiment is not limited to this. Further, in the above-described another embodiment, there is shown an example in which the image file of a compilation image is generated in image compilation processing in the image compilation mode. However, the present invention is not limited to the structures of the above-described embodiments. For example, the present invention may be applied with respect to the image file of a compilation image which is generated automatically by the electronic camera while photographing.

(6) In the above-described one embodiment, an example in which image files are recorded in one recording medium 22 is shown for simplicity, but as a matter of course, it is also possible to apply the present invention to the case where, for example, image files are recorded in dispersed manner among different recording media 22 when it is possible to connect plural recording media 22 to the recording I/F 16.

(7) In the above-described one embodiment, relating of image files is not limited to the case of an original image and a compilation image, and may be performed by commonalities in photographed locations obtained by the GPS, or by commonalities in photographed data and time.

(8) The user interface of the above-described one embodiment is merely an example, and the operation section and the display on the monitor 18 in the present invention can be changed as appropriate. For example, operations of the original image key, the compilation image key, and the return key may be assigned to the input buttons 25 without depending on the GUI. Further, the mode indication of the related image displaying mode is not limited to the text representation, and may be substituted for example by character representation or the like.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image processing apparatus, comprising:
a data reading section which reads a reproduced file selected from a first file including data of a first image together with metadata indicating a location of a second image related to said first image and a second file including the data of said first image but not including said metadata;
a controlling section which detects said metadata from said reproduced file; and
a display section which performs display of indicating existence of said second image on a first screen reproducing said first image of said reproduced file when said controlling section detects said metadata.
